(19) United States
(12) Patent Application Publication
(10) Pub. No.: US 2016/0070656 A1
(43) Pub. Date: Mar. 10, 2016

(54) WRITE PROTECTION MANAGEMENT SYSTEMS

(71) Applicant: QUALCOMM Incorporated, San Diego, CA (US)

(72) Inventors: Benish Babu, San Diego, CA (US); Yoni Kahana, Kfar Malal (IL); Hyunsuk Shin, San Diego, CA (US)

(21) Appl. No.: 14/838,995

(22) Filed: Aug. 28, 2015

Related U.S. Application Data
(60) Provisional application No. 62/046,301, filed on Sep. 5, 2014.

(51) Int. Cl. G06F 12/14; G06F 3/06

(52) U.S. Cl. CPC G06F 12/1433; G06F 3/0619; G06F 3/0622; G06F 3/0685; G06F 3/0637; G06F 2212/1052; G06F 2212/173

(57) ABSTRACT

Write protection management systems are disclosed. In this regard, in one exemplary aspect, a security control system is provided to authorize and write a specified number of data blocks to a write-protected region in a storage device. In another exemplary aspect, a write control system is provided to keep track of data blocks written to the write-protected region. The write control system automatically re-enables write protection on the write-protected region after the specified number of data blocks has been written to the write-protected region. By automatically protecting the write-protected region after writing the specified number of data blocks, it is possible to prevent unauthorized attempts to write to the write-protected region, thus ensuring data security and integrity in the write-protected region.

### PRIORITY CLAIM

The present application claims priority to U.S. Provisional Patent Application Ser. No. 62/046,301, filed on Sep. 5, 2014, and entitled “WRITE PROTECTION MANAGEMENT SCHEMES,” which is incorporated herein by reference in its entirety.

### BACKGROUND

I. Field of the Disclosure

The technology of the disclosure relates generally to writing data to storage media.

II. Background

Mobile communication devices have become increasingly common in current society. The prevalence of these mobile communication devices is driven in part by the many functions that are now enabled on such devices. Increased processing capabilities in such devices means that mobile communication devices have evolved from being purely communication tools into sophisticated mobile entertainment centers, thus enabling enhanced user experiences.

Mobile communication devices rely on storage media to store operating systems, system parameters, executable programs, and user data. Such storage media may be read only memory (ROM), random access memory (RAM), universal serial bus (USB) based storage media, universal flash storage (UFS), and/or embedded multimedia card (eMMC). Typically, the storage media is partitioned into protected regions and unprotected regions. The protected regions usually store highly critical data such as operating systems, system parameters, and sensitive user data (e.g., credentials). To ensure data integrity and security, only authorized users and/or programs are able to write to the protected regions under highly restrictive conditions. For example, the protected regions may be only open for updates by a designated system program when a mobile communication device is power-cycled or rebooted.

In some cases, multiple power-cycles or reboots may be required to update the protected regions in the mobile communication device, thus inconveniencing end-users. There may also be occasions when it is desirable to update selectively a portion of the protected regions. Hence, it may be desirable to provide improved write protection management systems in the mobile communications devices.

### SUMMARY OF THE DISCLOSURE

Aspects disclosed in the detailed description include write protection management systems. When write protection for a write-protected region in a storage device is disabled to allow, for example, an over-the-air (OTA) system update, the write protection may not be re-enabled until the storage device is power-cycled or rebooted, leaving the write-protected region vulnerable to malicious attacks. In this regard, in one exemplary aspect, a security control system is provided in a host device to authorize and write a specified number of data blocks to the write-protected region in the storage device. In another exemplary aspect, a write control system is provided in the storage device to keep track of data blocks written to the write-protected region. The write control system automatically re-enables the write protection on the write-protected region after the specified number of data blocks has been written to the write-protected region. By automatically protecting the write-protected region in both the host device and the storage device after writing the specified number of data blocks, it is possible to prevent unauthorized attempts to write to the write-protected region, thus ensuring data security and integrity in the write-protected region.

In this regard, in one aspect, a host device is provided. The host device comprises a security control system. The security control system is configured to validate a request for writing a specified number of data blocks to a write-protected region in a storage device communicatively coupled to the host device. The security control system is also configured to disable write protection on the write-protected region. The security control system is also configured to write the specified number of data blocks to the write-protected region. The security control system is also configured to stop writing any more data blocks to the write-protected region and enable the write protection on the write-protected region after writing the specified number of data blocks to the write-protected region.

In another aspect, a method for writing data to a write-protected region in a storage device is provided. The method comprises validating a request for writing a specified number of data blocks to a write-protected region in a storage device. The method also comprises disabling write protection on the write-protected region to write the specified number of data blocks to the write-protected region.

In another aspect, a storage device is provided. The storage device comprises a write-protected region that can be written to when write protection on the write-protected region is disabled. The storage device also comprises a write control system comprising a size register. The size register is configured to indicate if a plurality of data blocks written to the write-protected region reaches a specified number. For each data block among the plurality of data blocks, the write control system is configured to monitor the size register. For each data block among the plurality of data blocks, the write control system is also configured to allow the data block to be written to the write-protected region if the size register indicates the specified number is not reached. For each data block among the plurality of data blocks, the write control system is also configured to enable the write protection on the write-protected region to stop the data block from being written to the write-protected region if the size register indicates the specified number is reached.

In another aspect, a method for controlling data written to a write-protected region in a storage device is provided. The method comprises setting a specified number in a size register for writing a specified number of data blocks to a write-protected region in a storage device. The method also comprises disabling write protection on the write-protected region. The method also comprises allowing a data block to be written to the write-protected region if the size register indicates the specified number is not reached. The method also comprises enabling the write protection on the write-protected region if the size register indicates the specified number is reached.

### BRIEF DESCRIPTION OF THE FIGURES

FIG. 1 is a schematic diagram of an exemplary conventional write protection system in which a write-protected region in a storage device may be vulnerable to unauthorized write attempts subsequent to an authorized write operation;

FIG. 2 is an exemplary conventional time-based diagram illustrating a lapse of protection on the write-protected region of FIG. 1 due to inherent security vulnerabilities of the write protection system;

FIG. 3A is a schematic diagram of an exemplary write protection management system that overcomes the inherent security vulnerabilities of the conventional write protection system of FIG. 1 by employing a security control system in a host device and a write control system in a storage device;

FIG. 3B is a schematic diagram of an exemplary write protection management system in which the security control system in the host device of FIG. 3A is configured to enable write protection in the storage device via a storage device driver;

FIG. 4 is an exemplary time-based diagram illustrating elimination of the lapse of protection on the write-protected region of FIG. 1 by the write protection management systems of FIGS. 3A and 3B;

FIG. 5A is a schematic diagram of an exemplary electronic device configured to receive an over-the-air (OTA) update based on the write protection management system of FIG. 3A;

FIG. 5B is a schematic diagram of an exemplary electronic device configured to receive an OTA update based on the write protection management system of FIG. 3B;

FIG. 6A is an exemplary signal flow diagram illustrating signaling exchanges between the security control system and the write control system of FIG. 3A during the OTA update of FIG. 5A;

FIG. 6B is an exemplary signal flow diagram illustrating signaling exchanges between the security control system and the write control system of FIG. 3B during the OTA update of FIG. 5B;

FIG. 7 is a flowchart illustrating an exemplary security control process for writing data to a write-protected region in the storage device of FIGS. 3A and 3B;

FIG. 8 is a flowchart illustrating an exemplary write control process for controlling data written to a write-protected region in the storage device of FIGS. 3A and 3B; and

FIG. 9 is a block diagram of an exemplary processor-based system that can employ the write protection management systems of FIGS. 3A and 3B.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include write protection management systems. When write protection for a write-protected region in a storage device is disabled to allow, for example, an over-the-air (OTA) system update, the write protection may not be re-enabled until the storage device is power-cycled or rebooted, leaving the write-protected region vulnerable to malicious attacks. In this regard, in one exemplary aspect, a security control system is provided in a host device to authorize and write a specified number of data blocks to the write-protected region in the storage device. In another exemplary aspect, a write control system is provided in the storage device to keep track of data blocks written to the write-protected region. The write control system automatically re-enables the write protection on the write-protected region after the specified number of data blocks has been written to the write-protected region. By automatically protecting the write-protected region in both the host device and the storage device after writing the specified number of data blocks, it is possible to prevent unauthorized attempts to write to the write-protected region, thus ensuring data security and integrity in the write-protected region.

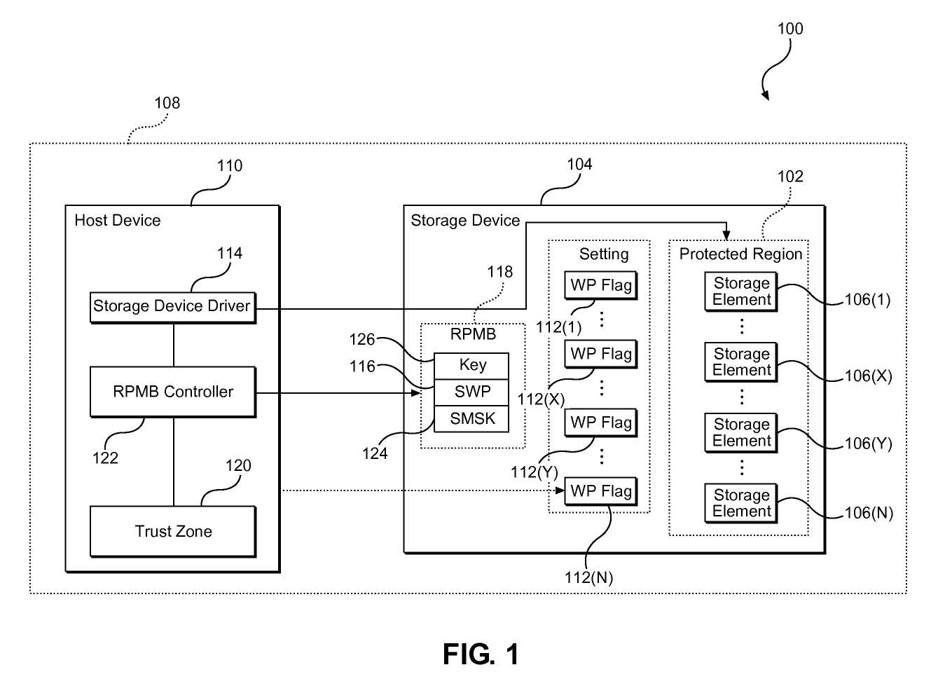

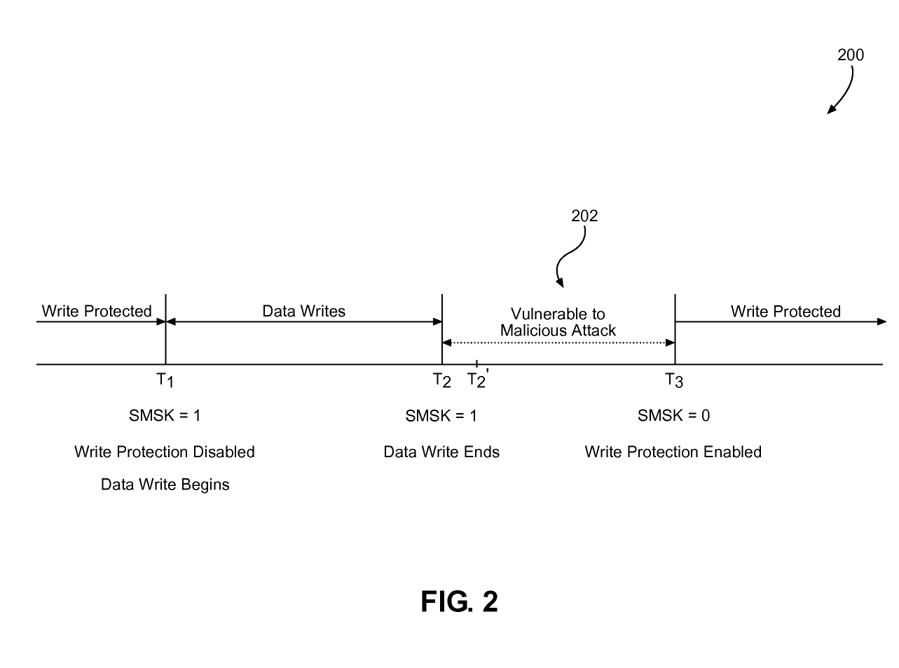

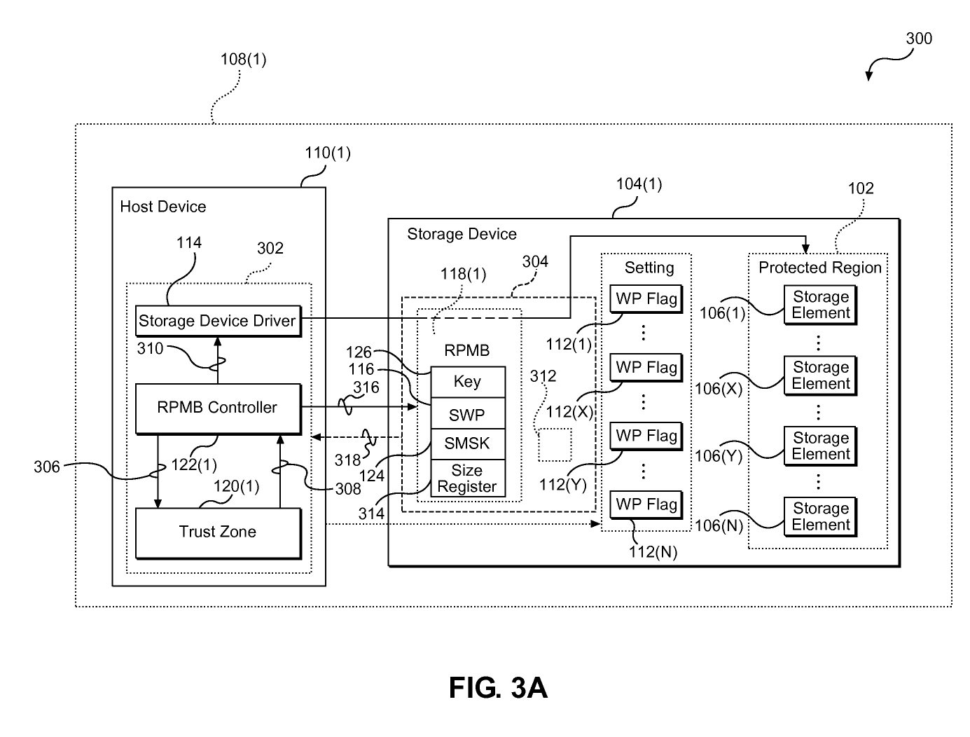

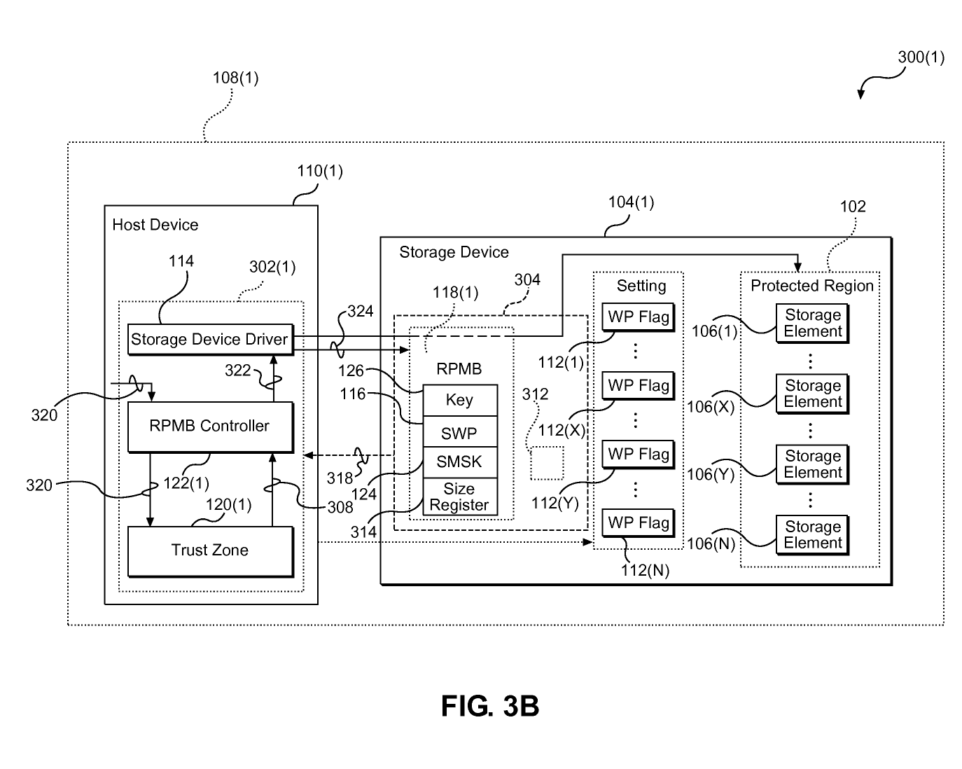

Before discussing exemplary aspects of write protection management systems that include specific aspects of the present disclosure, a brief overview of a conventional write protection system and an illustration of security vulnerability of the conventional write protection system are first provided in FIGS. 1-2. The discussion of specific exemplary aspects of the write protection management systems starts below with reference to FIG. 3A.

In this regard, FIG. 1 is a schematic diagram of an exemplary conventional write protection system 100 in which a write-protected region 102 (referenced in drawings as “protected region”) in a storage device 104 may be vulnerable to unauthorized write attempts subsequent to an authorized write operation. The write-protected region 102 comprises a plurality of storage elements 106(1)-106(N). In a non-limiting example, each storage element among the plurality of storage elements 106(1)-106(N) stores a respective data block (e.g., a data byte). In another non-limiting example, the storage device 104 may be a random access memory (RAM), a universal serial bus (USB) based storage device, a universal flash storage (UFS) based storage device, or an embedded multimedia card (eMMC) based storage device. In another non-limiting example, the storage device 104 may be integrated in an electronic device 108, such as a mobile communication device, a smartphone, a tablet, a personal computer, and so on.

With continuing reference to FIG. 1, a host device 110, which is communicatively coupled to the storage device 104, is configured to read data from or write data to the storage device 104 and, more specifically, the write-protected region 102. In a first non-limiting example, the host device 110 and the storage device 104 may be provided in discrete integrated circuits (ICs) or in a single IC in the electronic device 108. In a second non-limiting example, the host device 110 may be provided outside the electronic device 108 and the storage device 104 may be provided in the electronic device 108. In a third non-limiting example, the host device 110 may be provided in the electronic device 108 and the storage device 104 may be provided outside the electronic device 108. The write-protected region 102 may be configured to store operating systems, system parameters, and sensitive information such as user credentials. The conventional write protection system 100 employs multiple levels of write protection, which are discussed next, to prevent the write-protected region 102 from being accidentally or maliciously updated.

With continuing reference to FIG. 1, a first level write protection for the write-protected region 102 is provided by a plurality of write protection flags 112(1)-112(N) (referred to herein as WP flags) that corresponds to the plurality of storage elements 106(1)-106(N), respectively. In a non-limiting example, the plurality of WP flags 112(1)-112(N) is controlled by a high-level operating system (HLOS) (not shown) in the host device 110. In another non-limiting example, the HLOS may include Android™, Mac®OS, Windows®, Linux, Unix, and so on. For example, when the HLOS sets WP flag 112(X) from among the plurality of WP flags 112(1)-112(N) to one (1), write protection on storage element 106(X) from among the plurality of storage elements 106(1)-106(N) is disabled. As a result, the host device 110 is able to write to the storage element 106(X) through a storage device driver 114. When the HLOS sets the WP flag 112(X) to zero, the write protection on the storage element 106(X) is enabled and the host device 110 is unable to write to the storage element 106(X). The HLOS in the host device 110 provides an open execution environment in which any compatible applications, including malicious applications and spyware, may be executed. As a result, it may be possible for hackers to manipulate the plurality of WP flags 112(1)-112(N) to gain unauthorized access to the write-protected region 102.

With continuing reference to FIG. 1, to overcome vulnerabilities of the first level write protection, a second level write protection for the write-protected region 102 is provided by a secure write protection (SWP) flag 116. A replay protected memory block (RPMB) 118 in the storage device 104 provides the SWP flag 116. Unlike the plurality of WP flags 112(1)-112(N), the SWP flag 116 is controlled by a trust zone 120 in the host device 110 through an RPMB controller 122. In a non-limiting example, the trust zone 120 may be enabled and supported by trust zone processor architecture (not shown) in the host device 110. The trust zone 120 provides a secure execution environment that is isolated from the HLOS. The trust zone 120 is designed to allow only authenticated and authorized programs to execute and gain access to the write-protected region 102, thus preventing the malicious applications from gaining unauthorized access to the write-protected region 102.

The SWP flag 116 has a higher write protection authority than the plurality of WP flags 112(1)-112(N). In this regard, when the SWP flag 116 is set to one to disable the write protection on the write-protected region 102, the host device 110 is able to write to any storage element among the plurality of storage elements 106(1)-106(N), regardless of settings of the plurality of WP flags 112(1)-112(N). In addition, when the SWP flag 116 is set to one, the HLOS is able to change the settings of the plurality of WP flags 112(1)-112(N). In contrast, when the SWP flag 116 is set to zero to enable the write-protection on the write-protected region 102, the plurality of WP flags 112(1)-112(N) will determine whether the plurality of storage elements 106(1)-106(N) can be written to. Furthermore, the HLOS is unable to change the settings of the plurality of WP flags 112(1)-112(N) when the SWP flag 116 is set to zero.

With continuing reference to FIG. 1, a third level write protection for the write-protected region 102 is provided by a secure write protect mask (SMSK) 124, which is also included in the RPMB 118 in the storage device 104 and controlled by the trust zone 120 through the RPMB controller 122. To further strengthen the write protection on the write-protected region 102, the trust zone 120 is designed to enable or disable the SMSK 124 based on a validation key 126 stored in the RPMB 118. The SMSK 124 has a higher write protection authority than both the SWP flag 116 and the plurality of WP flags 112(1)-112(N). In this regard, when the SMSK 124 is set to one to disable the write protection on the write-protected region 102, the host device 110 is able to write to any storage element among the plurality of storage elements 106(1)-106(N), regardless of the values of the SWP flag 116 and the settings of the plurality of WP flags 112(1)-112(N). On the other hand, when the SMSK 124 is set to zero to enable the write protection on the write-protected region 102, the SWP flag 116 will in turn determine the write protection on the write-protected region 102 as described above.

The write protection hierarchy of the SMSK 124, the SWP flag 116, and the plurality of WP flags 112(1)-112(N) may be summarized by Table 1 below:

TABLE 1

| SMSK | SWP | WP | Write-Protected |
|---|---|---|---|
| (124) | (116) | (112(1)-112(N)) | Region (102) |
| 0 | 0 | 0 | Cannot be written |
| | | 1 | Can be written |
| | 1 | No effect | Can be written |

| | | |
|---|---|---|
| 1 | No effect | Can be written |

With continuing reference to FIG. 1, as discussed above, the trust zone 120 may change the SMSK 124 from one to zero to enable the write protection on the write-protected region 102 through the RPMB controller 122. Alternatively, the trust zone 120 may also change the SMSK 124 from one to zero by power-cycling the storage device 104. Regardless of which method the trust zone 120 uses to enable the write protection, the write-protected region 102 is left unprotected and vulnerable due to processing delays of the RPMB controller 122 or delays associated with power-cycling the storage device 104.

In this regard, FIG. 2 is an exemplary conventional time-based diagram 200 illustrating a lapse of protection on the write-protected region 102 of FIG. 1 due to inherent security vulnerabilities of the conventional write protection system 100. Elements of FIG. 1 are referenced in connection with FIG. 2 and will not be re-described herein.

With reference to FIG. 2, prior to time T₁, the SMSK 124 (not shown) is set to zero to enable the write protection on the write-protected region 102 (not shown). At time T₁, the SMSK 124 is changed to one to disable the write protection on the write-protected region 102, and the host device 110 (not shown) begins writing data to the write-protected region 102. At time T₂, the host device 110 has finished writing data to the write-protected region 102. The trust zone 120 (not shown), in the meantime, may not instruct the RPMB controller 122 (not shown) to enable the SMSK 124 until time T₂′. The RPMB controller 122, in turn, enables the SMSK 124 at time T₃. As such, a lapse of protection on the write-protected region 102 occurs between times T₁ and T₃. The lapse of protection creates an unprotected window 202 in which the write-protected region 102 is unprotected and vulnerable to malicious attacks. Hence, it may be desirable to eliminate the lapse of protection on the write-protected region 102 by closing the unprotected window 202.

In this regard, FIG. 3A is a schematic diagram of an exemplary write protection management system 300 that overcomes the potential security vulnerabilities of the conventional write protection system 100 of FIG. 1 by employing a security control system 302 in a host device 110(1) and a write control system 304 in a storage device 104(1). Common elements between FIGS. 1 and 3A are shown therein with common element numbers and thus, will not be re-described herein.

With reference to FIG. 3A, in a first non-limiting example, the host device 110(1) and the storage device 104(1) may be provided in discrete ICs or in a single IC in an electronic device 108(1). In a second non-limiting example, the host device 110(1) may be provided outside the electronic device 108(1) and the storage device 104(1) may be provided in the electronic device 108(1). In a third non-limiting example, the host device 110(1) may be provided in the electronic device 108(1) and the storage device 104(1) may be provided outside the electronic device 108(1).

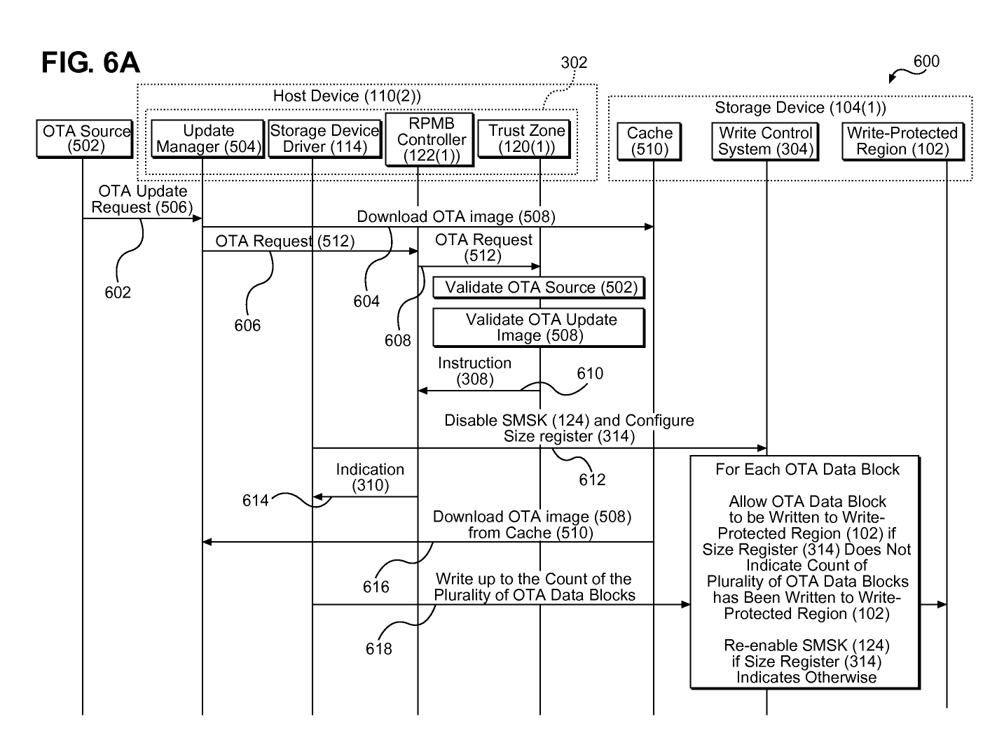

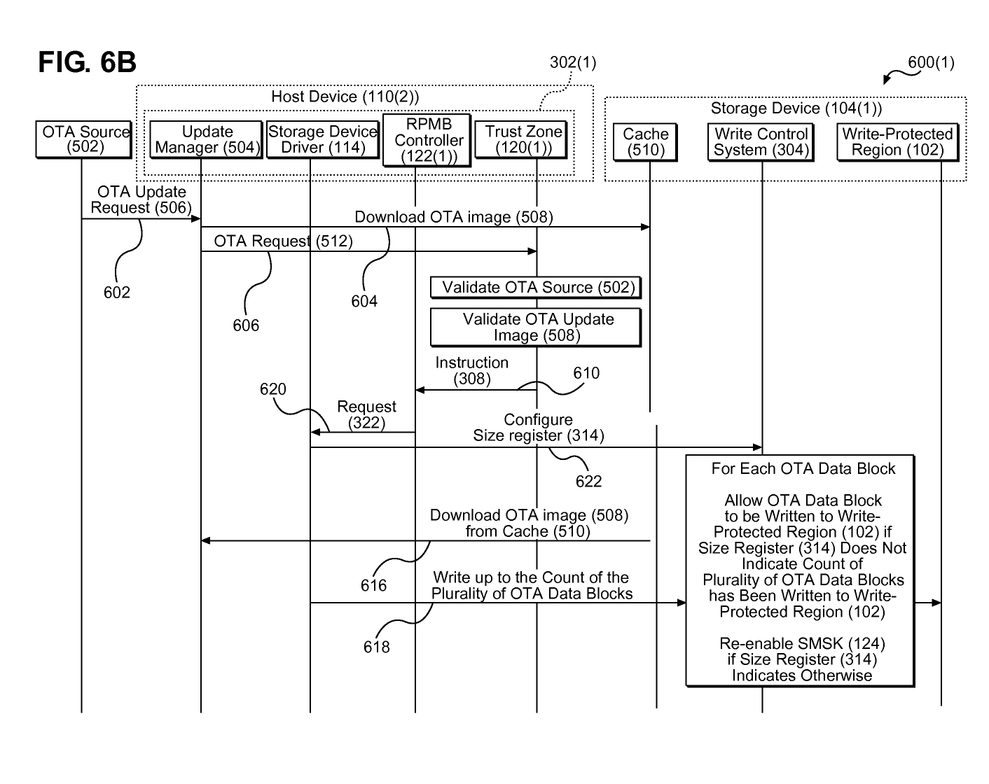

With continuing reference to FIG. 3A, the security control system 302 comprises the storage device driver 114, an RPMB controller 122(1), and a trust zone 120(1). In a non-limiting example, the security control system 302 may be provided in a central processing unit (CPU), a microprocessor, a digital signal processor (DSP), a micro-controller, or a field-programmable gate array (FPGA). To write data to the write-protected region 102 in the storage device 104(1), the RPMB controller 122(1) provides a request 306 to the trust zone 120(1) for writing a specified number of data blocks to the write-protected region 102. In a non-limiting example, the specified number of data blocks may be a specified number of data bytes. The specified number of data blocks may be programmably stored in non-volatile memory (not shown) of the host device 110(1) or the RPMB controller 122(1). The RPMB controller 122(1) may also determine the specified number of data blocks based on an OTA update request, which is discussed later with reference to FIG. 6A. Upon validating the request 306, the trust zone 120(1) instructs the RPMB controller 122(1) to disable the write protection on the write-protected region 102. In a non-limiting example, the trust zone 120(1) may instruct the RPMB controller 122(1) to disable the SMSK 124 by providing an instruction 308 to the RPMB controller 122(1). The RPMB controller 122(1) then disables the write protection on the write-protected region 102 by directly updating the SMSK 124 to one. Once the SMSK 124 is disabled, the storage device driver 114 can start writing the specified number of data blocks to the write-protected region 102. In a non-limiting example, the RPMB controller 122(1) may generate an indication 310 to instruct the storage device driver 114 to start writing the specified number of data blocks to the write-protected region 102.

With continuing reference to FIG. 3A, the write control system 304 comprises a RPMB 118(1). The RPMB 118(1) comprises the SWP flag 116, the SMSK 124, the validation key 126, a protection controller 312, and a size register 314. The RPMB controller 122(1) configures the size register 314 to indicate if the storage device driver 114 in the host device 110(1) has written the specified number of data blocks to the write-protected region 102. In a non-limiting example, the RPMB controller 122(1) may provide the specified number of data blocks authorized to be written to the write-protected region 102 to the RPMB 118(1) via a configuration signal 316. The write control system 304 is configured to allow a data block to be written to the write-protected region 102 if the size register 314 indicates that the storage device driver 114 has not written the specified number of data blocks to the write-protected region 102. The protection controller 312 in the write control system 304 is also configured to re-enable the SMSK 124 by setting the SMSK 124 to zero if the size register 314 indicates that the storage device driver 114 has written the specified number of data blocks to the write-protected region 102. In this regard, in a non-limiting example, the write control system 304 in the storage device 104(1) may be configured to provide a control signal 318 to the security control system 302 to indicate that the specified number of data blocks has been written to the write-protected region 102. As such, the write control system 304 is able to prevent unauthorized access to the write-protected region 102 as soon as the specified number of data blocks is written to the write-protected region 102, regardless of whether the SMSK 124 is enabled.

With continuing reference to FIG. 3A, the size register 314 has a higher write protection authority than the SMSK 124, the SWP flag 116, and the plurality of WP flags 112(1)-112(N). The write protection hierarchy of the size register 314, the SMSK 124, the SWP flag 116, and the plurality of WP flags 112(1)-112(N) may be summarized by Table 2 below:

TABLE 2

| Size Register | SMSK | SWP | WP | Write-Protected |
|---|---|---|---|---|
| (314) | (124) | (116) | (112(1)-112(N)) | Region (102) |
| Data blocks | 0 | 0 | 0 | Cannot be written |
| written to write- | | | 1 | Can be written |
| protected region | | 1 | No effect | Can be written |

| | | | |
|---|---|---|---|
| (102) are less | 1 | No effect | Can be written |
| than specified | | | |
| number of data | | | |
| blocks | | | |

| | | |
|---|---|---|
| Data blocks | No effect | Cannot be written |
| written to write- | | |
| protected region | | |
| (102) equal | | |
| specified number | | |
| of data blocks | | |

With continuing reference to FIG. 3A, in a first non-limiting example, the size register 314 may be implemented as a countdown register. In this regard, the RPMB controller 122(1) initializes the size register 314 to the specified number of data blocks to be written to the write-protected region 102 via the configuration signal 316. The size register 314 decreases by one for each data block the storage device driver 114 writes to the write-protected region 102. As such, the write control system 304 blocks any more data blocks from being written to the write-protected region 102 if the size register 314 equals zero. In a second non-limiting example, the size register 314 may be implemented as an incremental register. In this regard, the RPMB controller 122(1) initializes the size register 314 to zero via the configuration signal 316. The size register 314 increases by one for each data block the storage device driver 114 writes to the write-protected region 102. As such, the write control system 304 blocks any more data blocks from being written to the write-protected region 102 if the size register 314 equals the specified number of data blocks.

Alternative to disabling the SMSK 124 and configuring the size register 314 via the RPMB controller 122(1), it is also possible to disable the SMSK 124 and configure the size register 314 via the storage device driver 114. In this regard, FIG. 3B is a schematic diagram of an exemplary write protection management system 300(1) in which a security control system 302(1) in the host device 110(1) of FIG. 3A is configured to enable the write protection on the write-protected region 102 via the storage device driver 114. Common elements between FIGS. 3A and 3B are shown therein with common element numbers and thus, will not be re-described herein.

With reference to FIG. 3B, the security control system 302(1) includes the storage device driver 114, the RPMB controller 122(1), and the trust zone 120(1). To write data to the write-protected region 102 in the storage device 104(1), the trust zone 120(1) may receive a request 320 for writing the specified number of data blocks to the write-protected region 102. In a non-limiting example, the HLOS (not shown) of the host device 110(1) may provide the request 320 to the trust zone 120(1) through the RPMB controller 122(1). In another non-limiting example, the specified number of data blocks may be a specified number of data bytes. The trust zone 120(1) may determine the specified number of data blocks based on an OTA update request, which is discussed later with reference to FIG. 6B. Upon validating the request 320, the trust zone 120(1) instructs the RPMB controller 122(1) to disable the write protection on the write-protected region 102. In a non-limiting example, the trust zone 120(1) may instruct the RPMB controller 122(1) to disable the SMSK 124 by providing the instruction 308 to the RPMB controller 122(1). The RPMB controller 122(1) then requests the storage device driver 114 to initialize the size register 314 and disable the write protection on the write-protected region 102 by providing a request 322. In response, the storage device driver 114 provides the specified number of data blocks authorized to be written to the write-protected region 102 to the RPMB 118(1) and updates the SMSK 124 to one via a configuration signal 324. The write control system 304 is configured to allow a data block to be written to the write-protected region 102 if the size register 314 indicates that the storage device driver 114 has not written the specified number of data blocks to the write-protected region 102. The protection controller 312 in the write control system 304 is also configured to re-enable the SMSK 124 by setting the SMSK 124 to zero if the size register 314 indicates that the storage device driver 114 has written the specified number of data blocks to the write-protected region 102. In this regard, in a non-limiting example, the write control system 304 in the storage device 104(1) may be configured to provide the control signal 318 to the security control system 302 to indicate that the specified number of data blocks has been written to the write-protected region 102. As such, the write control system 304 is able to prevent unauthorized access to the write-protected region 102 as soon as the specified number of data blocks is written to the write-protected region 102, regardless of whether the SMSK 124 is enabled.

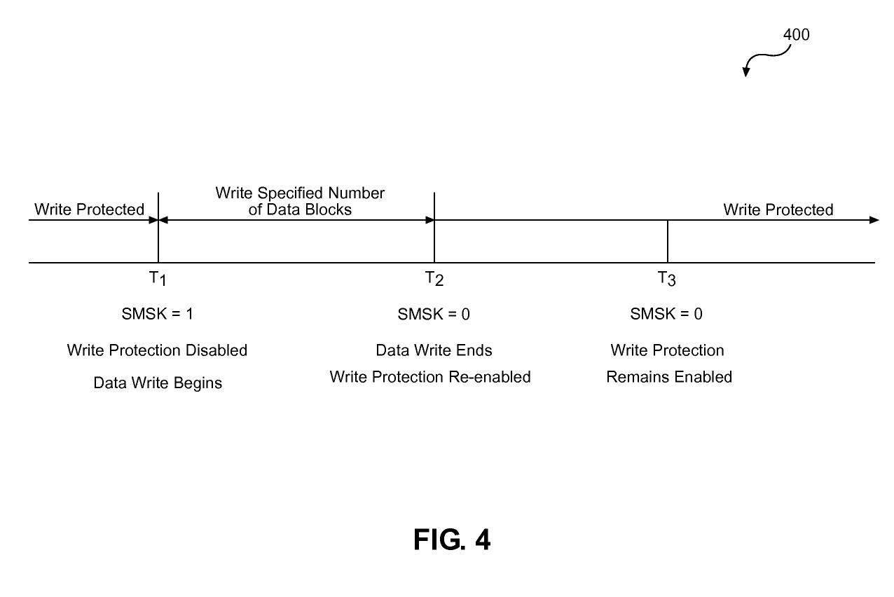

The write control system 304 can effectively protect the write-protected region 102 from unauthorized access by eliminating the unprotected window 202 of FIG. 2. In this regard, FIG. 4 is an exemplary time-based diagram illustrating elimination of the lapse of protection on the write-protected region of FIG. 1 by the security control system 302 and the write control system 304 of FIGS. 3A and 3B.

FIG. 4 is an exemplary time-based diagram 400 illustrating elimination of the lapse of protection on the write-protected region 102 by the write protection management system 300 of FIG. 3A and the write protection management system 300(1) of FIG. 3B. Elements of FIGS. 3A and 3B are referenced in connection with FIG. 4 and will not be re-described herein.

With reference to FIG. 4, prior to time T₁, the SMSK 124 (not shown) is set to zero to enable the write protection on the write-protected region 102 not shown). At time T₁, the RPMB controller 122(1) changes the SMSK 124 to one to disable the write protection on the write-protected region 102, and the storage device driver 114 (not shown) begins writing the specified number of data blocks to the write-protected region 102. At time T₂, the storage device driver 114 has finished writing the specified number of data blocks to the write-protected region 102. According to the discussions above, the protection controller 312 in the storage device 104(1) re-enables the SMSK 124 by setting the SMSK 124 to zero. In this regard, the write protection on the write-protected region 102 is effectively resumed at time T₂ without requiring power-cycling or rebooting the storage device 104(1). In a non-limiting example, the protection controller 312 may re-enable the write protection on the write-protected region 102 slightly ahead of or slightly after the time T₂ as long as the variation is reasonable. As a result, there is no lapse of protection on the write-protected region 102.

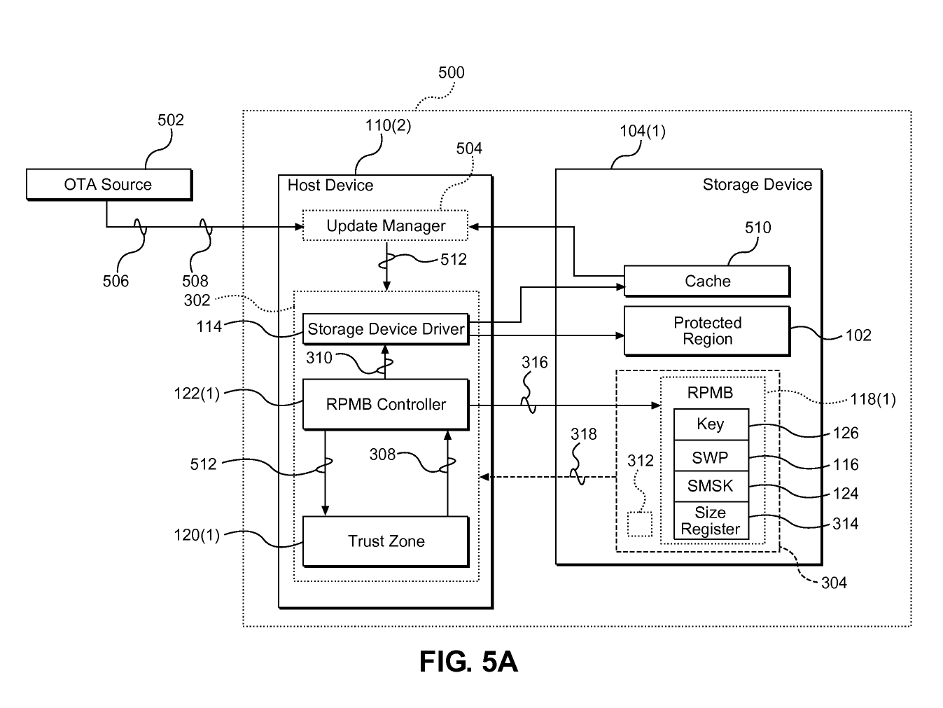

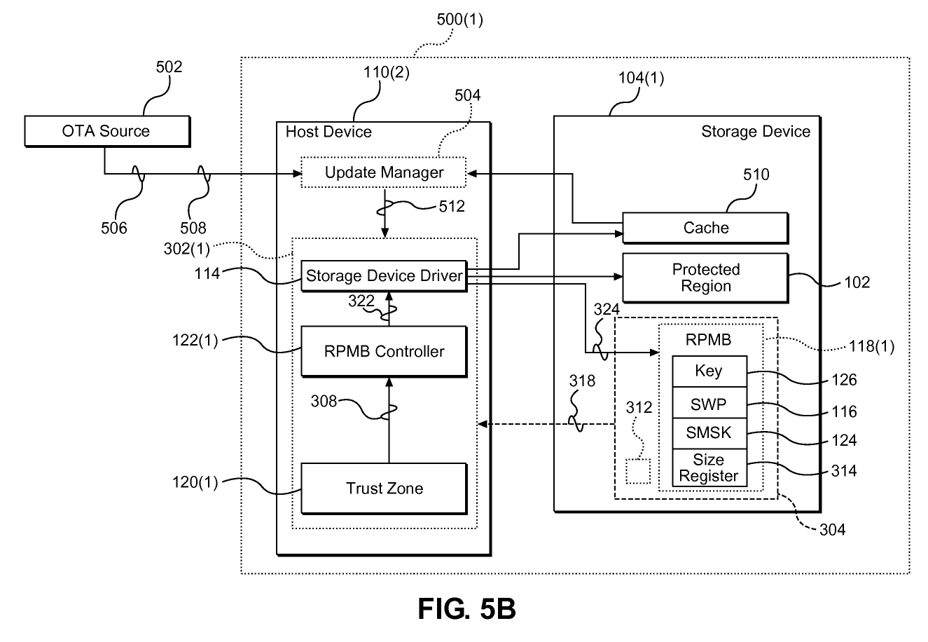

The security control system 302 and the write control system 304 of FIG. 3A may be employed to provide an OTA update to the electronic device 108(1). In this regard, FIG. 5A is a schematic diagram of an exemplary electronic device 500 configured to receive an OTA update based on the write protection management system 300 of FIG. 3A. Common elements between FIGS. 3A and 5A are shown therein with common element numbers and thus, will not be re-described herein.

With reference to FIG. 5A, the electronic device 500 receives the OTA update from an OTA source 502. The electronic device 500 comprises a host device 110(2), which further comprises an update manager 504. The update manager 504 is communicatively coupled to the OTA source 502 to receive an OTA update request 506. In response to receiving the OTA update request 506, the update manager 504 downloads an OTA update image 508 from the OTA source 502. The OTA update image 508 comprises a plurality of OTA data blocks (e.g., data bytes). In a non-limiting example, the update manager 504 may store the OTA update image 508 in a cache 510 in the storage device 104(1) or alternatively in a host cache (not shown) in the host device 110(2). Subsequently, the update manager 504 provides an OTA request 512 to the security control system 302 in the host device 110(2). In a non-limiting example, the OTA request 512 includes an identification of the OTA source 502, at least one unlock command (not shown), and a count of the plurality of OTA data blocks comprised in the OTA update image 508.

With continuing reference to FIG. 5A, in a non-liming example, the RPMB controller 122(1) receives the OTA request 512 from the update manager 504 and provides the OTA request 512 to the trust zone 120(1). In response to receiving the OTA request 512, the trust zone 120(1) validates the OTA source 502 based on the identification of the OTA source 502. In addition, the trust zone 120(1) also validates the OTA update image 508 based on the at least one unlock command. Upon successful validations of the OTA source 502 and the OTA update image 508, the trust zone 120(1) instructs the RPMB controller 122(1) to disable the write protection on the write-protected region 102 to allow up to the count of the plurality of OTA data blocks to be written to the write-protected region 102. In this regard, the count of the plurality of OTA data blocks defines the specified number of data blocks to be written to the write-protected region 102. In a non-limiting example, the trust zone 120(1) may instruct the RPMB controller 122(1) by providing the instruction 308.

In response to receiving the instruction 308, the RPMB controller 122(1) configures the write control system 304 via the configuration signal 316 to allow up to the count of the plurality of OTA data blocks to be written to the write-protected region 102. According to previous discussions in reference to FIG. 3A, the write control system 304 may configure the size register 314 as the countdown register or the incremental register. If the size register 314 is configured as the countdown register, the write control system 304 initializes the size register 314 to the count of the plurality of OTA data blocks. If the size register 314 is configured as the incremental register, the write control system 304 initializes the size register 314 to zero. Subsequently, the RPMB controller 122(1) disables the write protection on the write-protected region 102 by setting the SMSK 124 to one. The RPMB controller then instructs the storage device driver 114 to write up to the count of the OTA data blocks to the write-protected region 102. In a non-limiting example, the RPMB controller 122(1) may instruct the storage device driver by providing the indication 310.

With continuing reference to FIG. 5A, the storage device driver 114 downloads the OTA update image 508 from the cache 510 and writes the OTA update image 508 to the write-protected region 102. The write control system 304 in the storage device 104(1) uses the size register 314 to keep track of the number of OTA data blocks being written to the write-protected region 102. The protection controller 312 in the write control system 304 re-enables the SMSK 124 by setting the SMSK 124 to zero once the size register 314 indicates that the count of the plurality of OTA data blocks has been written to the write-protected region 102. By enforcing the write protection on the write-protected region 102 both in the host device 110(2) and the storage device 104(1), it is possible to ensure data security and integrity during the OTA update.

The security control system 302(1) and the write control system 304 of FIG. 3B may also be employed to provide an OTA update to the electronic device 108(1). In this regard, FIG. 5B is a schematic diagram of an exemplary electronic device 500(1) configured to receive an OTA update based on the write protection management system 300(1) of FIG. 3B. Common elements between FIGS. 3B and 5B are shown therein with common element numbers and thus, will not be re-described herein.

With reference to FIG. 5B, in a non-liming example, the trust zone 120(1) receives the OTA request 512 from the update manager 504. In response to receiving the OTA request 512, the trust zone 120(1) validates the OTA source 502 based on the identification of the OTA source 502. In addition, the trust zone 120(1) also validates the OTA update image 508 based on the at least one unlock command. Upon successful validations of the OTA source 502 and the OTA update image 508, the trust zone 120(1) instructs the RPMB controller 122(1) to disable the write protection on the write-protected region 102 to allow up to the count of the plurality of OTA data blocks to be written to the write-protected region 102. In this regard, the count of the plurality of OTA data blocks defines the specified number of data blocks to be written to the write-protected region 102. In a non-limiting example, the trust zone 120(1) may instruct the RPMB controller 122(1) by providing the instruction 308. The RPMB controller 122(1) then requests the storage device driver 114 to initialize the size register 314 and disable the write protection on the write-protected region 102 by providing the request 322. In response, the storage device driver 114 provides the specified number of data blocks authorized to be written to the write-protected region 102 to the RPMB 118(1) and updates the SMSK 124 to one via the configuration signal 324.

With continuing reference to FIG. 5B, the storage device driver 114 downloads the OTA update image 508 from the cache 510 and writes the OTA update image 508 to the write-protected region 102. The write control system 304 in the storage device 104(1) uses the size register 314 to keep track of the number of OTA data blocks being written to the write-protected region 102. The protection controller 312 in the write control system 304 re-enables the SMSK 124 by setting the SMSK 124 to zero once the size register 314 indicates that the count of the plurality of OTA data blocks has been written to the write-protected region 102. By enforcing the write protection on the write-protected region 102 both in the host device 110(2) and the storage device 104(1), it is possible to ensure data security and integrity during the OTA update.

FIG. 6A is an exemplary signal flow diagram 600 illustrating signaling exchanges between the security control system 302 and the write control system 304 of FIG. 3A during the OTA update of FIG. 5A. Elements of FIGS. 3A and 5A are referenced in connection to FIG. 6A and will not be re-described herein.

With reference to FIG. 6A, the OTA source 502 initiates the OTA update by providing the OTA update request 506 to the update manager 504 (signal 602). In response to receiving the OTA update request 506, the update manager 504 downloads the OTA update image 508 from the OTA source 502 to the cache 510 in the storage device 104(1) (signal 604). The update manager 504 then provides the OTA request 512 to RPMB controller 122(1) in the security control system 302 in the host device 110(2) (signal 606). The OTA request 512 may include the identification of the OTA source 502, the at least one unlock command (not shown), and the count of the plurality of OTA data blocks comprised in the OTA update image 508.

With continuing reference to FIG. 6A, the RPMB controller 122(1) in the security control system 302 receives the OTA request 512 and provides the OTA request 512 to the trust zone 120(1) (signal 608). The trust zone 120(1) validates the OTA source 502 based on the identification of the OTA source 502. In a non-limiting example, the trust zone 120(1) may validate the OTA source 502 by verifying a signature (not shown) of the OTA request 512, a chain-of-trust of the validation key 126 (not shown) against a trusted certificate (not shown), and/or an anti-replay mechanism (not shown). The trust zone 120(1) also validates the OTA update image 508 based on the at least one unlock command. The trust zone 120(1) then instructs the RPMB controller 122(1) to disable the write protection on the write-protected region 102 with the instruction 308 (signal 610). Subsequently, the RPMB controller 122(1) disables the SMSK 124 and configures the size register 314 in the storage device 104(1) (signal 612). The RPMB controller 122(1) then provides the indication 310 to the storage device driver 114 to begin writing the OTA update image 508 to the write-protected region 102 (signal 614). The storage device driver 114 then downloads the OTA update image 508 from the cache 510 (signal 616) and writes the OTA update image 508 to the write-protected region 102 (signal 618).

With continuing reference to FIG. 6A, the write control system 304 in the storage device 104(1) monitors each OTA data block being written to the write-protected region 102 based on the size register 314. The write control system 304 allows the OTA data block to be written to the write-protected region 102 if the size register 314 does not indicate the count of the plurality of OTA data blocks has been written to the write-protected region 102. The protection controller 312 in the write control system 304 re-enables the SMSK 124 if the size register 314 indicates the count of the plurality of OTA data blocks has been written to the write-protected region 102.

FIG. 6B is an exemplary signal flow diagram 600(1) illustrating signaling exchanges between the security control system 302(1) and the write control system 304 of FIG. 3B during the OTA update of FIG. 5B. Elements of FIGS. 3B and 5B are referenced in connection to FIG. 6A and will not be re-described herein.

With reference to FIG. 6B, the OTA source 502 initiates the OTA update by providing the OTA update request 506 to the update manager 504 (signal 602). In response to receiving the OTA update request 506, the update manager 504 downloads the OTA update image 508 from the OTA source 502 to the cache 510 in the storage device 104(1) (signal 604). The update manager 504 then provides the OTA request 512 to the trust zone 120(1) in the security control system 302(1) in the host device 110(2) (signal 606). The OTA request 512 may include the identification of the OTA source 502, the at least one unlock command (not shown), and the count of the plurality of OTA data blocks comprised in the OTA update image 508.

With continuing reference to FIG. 6B, the trust zone 120(1) validates the OTA source 502 based on the identification of the OTA source 502. In a non-limiting example, the trust zone 120(1) may validate the OTA source 502 by verifying a signature (not shown) of the OTA request 512, a chain-of-trust of the validation key 126 (not shown) against a trusted certificate (not shown), and/or an anti-replay mechanism (not shown). The trust zone 120(1) also validates the OTA update image 508 based on the at least one unlock command. The trust zone 120(1) then instructs the RPMB controller 122(1) to disable the write protection on the write-protected region 102 with the instruction 308 (signal 610). The RPMB controller 122(1) then requests the storage device driver 114 to initialize the size register 314 and disable the write protection on the write-protected region 102 by providing the request 322 (signal 620). In response, the storage device driver 114 provides the specified number of data blocks authorized to be written to the write-protected region 102 to the RPMB 118(1) and updates the SMSK 124 to one via the configuration signal 324 (signal 622). The update manager 504 then downloads the OTA update image 508 from the cache 510 (signal 616). Subsequently, the storage device driver 114 writes the OTA update image 508 downloaded by the update manager 504 to the write-protected region 102 (signal 618).

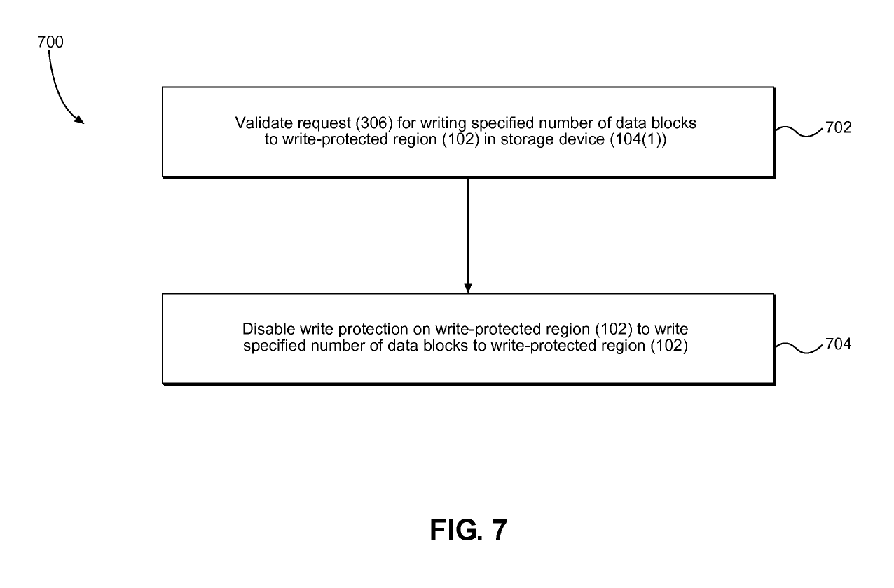

FIG. 7 is a flowchart illustrating an exemplary security control process 700 for writing data to the write-protected region 102 in the storage device 104(1) of FIGS. 3A and 3B. Elements of FIGS. 3A and 3B are referenced in connection with FIG. 7 and will not be re-described herein.

According to the security control process 700, the trust zone 120(1) validates the request 306 for writing the specified number of data blocks to the write-protected region 102 in the storage device 104(1) (block 702). The trust zone 120(1) then instructs the RPMB controller 122(1) to disable the write protection on the write-protected region 102 to write the specified number of data blocks to the write-protected region 102 (block 704).

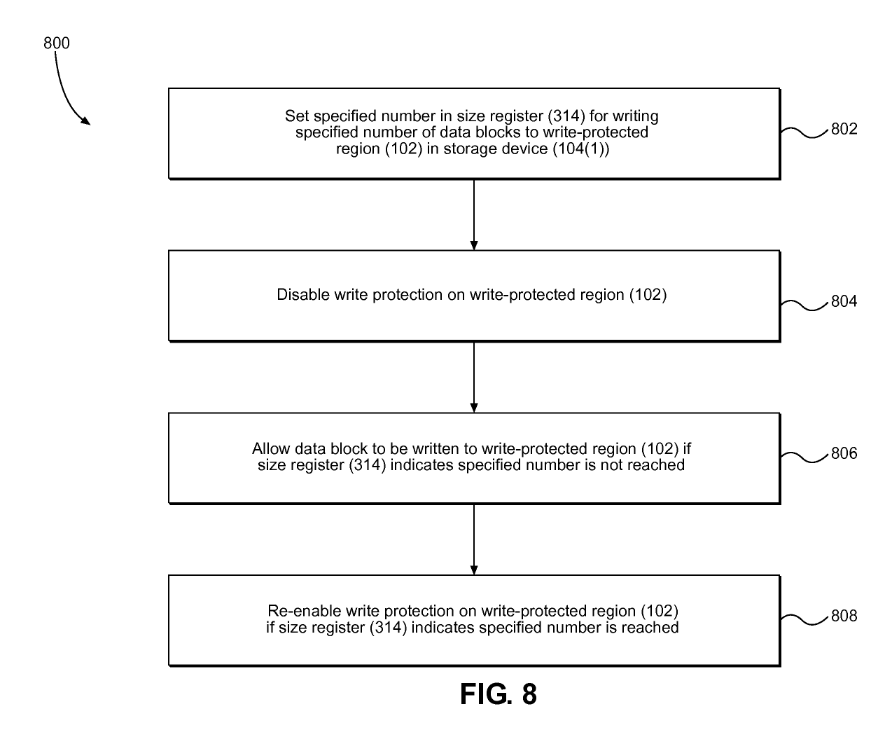

FIG. 8 is a flowchart illustrating an exemplary write control process 800 for controlling data written to the write-protected region 102 in the storage device 104(1) of FIGS. 3A and 3B. Elements of FIGS. 3A and 3B are referenced in connection with FIG. 8 and will not be re-described herein.

According to the write control process 800, the RPMB controller 122(1) sets a specified number in the size register 314 for writing the specified number of data blocks to the write-protected region 102 in the storage device 104(1) (block 802). The RPMB controller 122(1) then disables the write protection on the write-protected region 102 (block 804). The write control system 304 is configured to allow a data block to be written to the write-protected region 102 if the size register 314 indicates the specified number is not reached (block 806). The protection controller 312 in the write control system 304 is also configured to re-enable the write protection on the write-protected region 102 by setting the SMSK 124 to zero if the size register 314 indicates the specified number is reached (block 808).

The write protection management system according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a smartphone, a phablet, a tablet, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

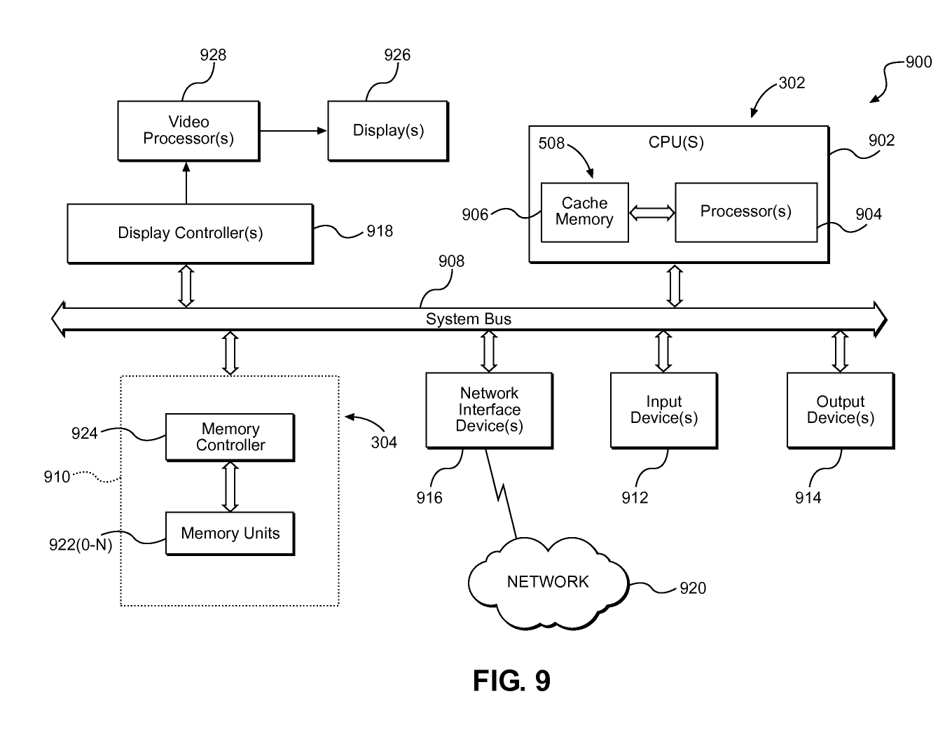

In this regard, FIG. 9 illustrates an example of a processor-based system 900 that can employ the write protection management system 300 of FIG. 3A and the write protection management system 300(1) of FIG. 3B. In this example, the processor-based system 900 includes one or more central processing units (CPUs) 902, each including one or more processors 904. The CPU(s) 902 may have cache memory 906 coupled to the processor(s) 904 for rapid access to temporarily stored data. In this regard, the security control system 302 of FIGS. 3A and 3B may be implemented by the CPU(s) 902. In addition, the OTA update image 508 of FIGS. 5A and 5B may be stored in the cache memory 906. The CPU(s) 902 is coupled to a system bus 908. As is well known, the CPU(s) 902 communicates with other devices by exchanging address, control, and data information over the system bus 908. Although not illustrated in FIG. 9, multiple system buses 908 could be provided, in which each system bus 908 constitutes a different fabric.

Other devices can be connected to the system bus 908. As illustrated in FIG. 9, these devices can include a memory system 910, one or more input devices 912, one or more output devices 914, one or more network interface devices 916, and one or more display controllers 918, as examples. In this regard, the write control system 304 of FIGS. 3A and 3B may be provided in the memory system 910. The input device(s) 912 can include any type of input device, including, but not limited to, input keys, switches, voice processors, etc. The output device(s) 914 can include any type of output device, including, but not limited to, audio, video, other visual indicators, etc. The network interface device(s) 916 can be any device configured to allow exchange of data to and from a network 920. The network 920 can be any type of network, including, but not limited to, a wired or wireless network, a private or public network, a local area network (LAN), a wireless LAN (WLAN), a wide area network (WAN), a BLUETOOTH™ network, or the Internet. The network interface device(s) 916 can be configured to support any type of communications protocol desired. The memory system 910 can include one or more memory units 922(0-N) and a memory controller 924.

The CPU(s) 902 may also be configured to access the display controller(s) 918 over the system bus 908 to control information sent to one or more displays 926. The display controller(s) 918 sends information to the display(s) 926 to be displayed by one or more video processors 928, which process the information to be displayed into a format suitable for the display(s) 926. The display(s) 926 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in RAM, flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A host device comprising a security control system configured to:
validate a request for writing a specified number of data blocks to a write-protected region in a storage device communicatively coupled to a host device;
disable write protection on the write-protected region;
write the specified number of data blocks to the write-protected region; and
stop writing any more data blocks to the write-protected region and enable the write protection on the write-protected region after writing the specified number of data blocks to the write-protected region.

2. The host device of claim 1, wherein the specified number of data blocks is a specified number of data bytes.

3. The host device of claim 1, wherein the security control system comprises:
a trust zone configured to validate the request for writing the specified number of data blocks to the write-protected region;
a replay protected memory block (RPMB) controller configured to disable the write protection on the write-protected region based on an instruction received from the trust zone; and
a storage device driver configured to write the specified number of data blocks to the write-protected region after the write protection on the write-protected region is disabled.

4. The host device of claim 1, wherein the security control system comprises:
a trust zone configured to validate the request for writing the specified number of data blocks to the write-protected region; and
a storage device driver configured to:
disable the write protection on the write-protected region based on an instruction provided by the trust zone; and
write the specified number of data blocks to the write-protected region after the write protection on the write-protected region is disabled.

5. The host device of claim 1, wherein the storage device comprises a write control system configured to provide a control signal to the security control system to indicate that the specified number of data blocks has been written to the write-protected region.

6. The host device of claim 1, wherein the security control system comprises an update manager configured to:
download an over-the-air (OTA) update image from an OTA source in response to receiving an OTA update request from the OTA source, wherein the OTA update image comprises a plurality of OTA data blocks; and
provide an OTA request to the security control system, wherein the OTA request comprises an identification of the OTA source, at least one unlock command, and a count of the plurality of OTA data blocks comprised in the OTA update image.

7. The host device of claim 6, wherein the security control system further comprises:
a trust zone;
a replay protected memory block (RPMB) controller configured to receive and provide the OTA request to the trust zone;
the trust zone configured to:
validate the OTA source and the OTA update image based on the identification of the OTA source and the at least one unlock command, respectively; and
instruct the RPMB controller to disable the write protection on the write-protected region to allow up to the count of the plurality of OTA data blocks to be written to the write-protected region;
the RPMB controller further configured to disable the write protection on the write-protected region; and
a storage device driver configured to write up to the count of the plurality of OTA data blocks to the write-protected region.

8. The host device of claim 6, wherein the security control system further comprises:
a trust zone configured to:
validate the OTA source and the OTA update image based on the identification of the OTA source and the at least one unlock command, respectively; and
generate an instruction to disable the write protection on the write-protected region to allow up to the count of the plurality of OTA data blocks to be written to the write-protected region; and
a storage device driver configured to:
disable the write protection on the write-protected region in response to receiving the instruction from the trust zone; and
write up to the count of the plurality of OTA data blocks to the write-protected region.

9. The host device of claim 1, wherein the security control system is provided in a central processing unit (CPU), a microprocessor, a digital signal processor (DSP), a micro-controller, or a field-programmable gate array (FPGA).

10. The host device of claim 1 integrated into an integrated circuit (IC) with the storage device.

11. The host device of claim 1 integrated into a discrete integrated circuit (IC) without the storage device.

12. The host device of claim 1 integrated into a device selected from the group consisting of: a set top box; an entertainment unit; a navigation device; a communications device; a fixed location data unit; a mobile location data unit; a mobile phone; a cellular phone; a computer; a portable computer; a smartphone; a phablet; a tablet; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

13. A method for writing data to a write-protected region in a storage device, comprising:
validating a request for writing a specified number of data blocks to a write-protected region in a storage device; and
disabling write protection on the write-protected region to write the specified number of data blocks to the write-protected region.

14. The method of claim 13, further comprising automatically enabling the write protection on the write-protected region after writing the specified number of data blocks to the write-protected region without power-cycling or rebooting the storage device.

15. The method of claim 13, further comprising:
validating a request for writing a specified number of data bytes to the write-protected region in the storage device; and
disabling the write protection on the write-protected region to write the specified number of data bytes to the write-protected region.

16. A storage device, comprising:
a write-protected region that can be written to when write protection on the write-protected region is disabled;
a write control system comprising a size register, the size register configured to indicate if a plurality of data blocks written to the write-protected region reaches a specified number; and
for each data block among the plurality of data blocks, the write control system configured to:
monitor the size register;
allow the data block to be written to the write-protected region if the size register indicates the specified number is not reached; and
enable the write protection on the write-protected region to stop the data block from being written to the write-protected region if the size register indicates the specified number is reached.

17. The storage device of claim 16, wherein the write control system is further configured to update the size register to account for each data block among the plurality of data blocks written to the write-protected region.

18. The storage device of claim 16, wherein the write control system is further configured to:
initialize the size register to the specified number; and
for each data block among the plurality of data blocks:
enable the write protection on the write-protected region to stop the data block from being written to the write-protected region if the size register equals zero; and
decrease the size register by one if the size register does not equal zero.

19. The storage device of claim 16, wherein the write control system is further configured to:
initialize the size register to zero;
for each data block among the plurality of data blocks:
enable the write protection on the write-protected region to stop the data block from being written to the write-protected region if the size register equals the specified number; and
increase the size register by one if the size register does not equal the specified number.

20. The storage device of claim 16, wherein the write control system further comprises a secure write protect mask (SMSK) and a secure write protect (SWP) flag, the SMSK and the SWP flag configured to enable or disable the write protection on the write-protected region.

21. The storage device of claim 20, wherein the write control system is further configured to enable the write protection on the write-protected region by setting the SMSK to zero.

22. The storage device of claim 20, wherein the write control system is further configured to disable the write protection on the write-protected region by setting the SMSK to one.

23. The storage device of claim 22, wherein the write control system is further configured to enable the write protection on the write-protected region by setting the SWP flag to zero when the SMSK is set to one.

24. The storage device of claim 16, wherein the write control system is provided in a universal serial bus (USB) based storage device, a universal flash storage (UFS) based storage device, an embedded multimedia card (eMMC) based storage device, or a random access memory (RAM).

25. The storage device of claim 16 integrated into an integrated circuit (IC).

26. The storage device of claim 16 integrated into a device selected from the group consisting of: a set top box; an entertainment unit; a navigation device; a communications device; a fixed location data unit; a mobile location data unit; a mobile phone; a cellular phone; a computer; a portable computer; a smartphone; a phablet; a tablet; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

27. A method for controlling data written to a write-protected region in a storage device, comprising:
setting a specified number in a size register for writing a specified number of data blocks to a write-protected region in a storage device;
disabling write protection on the write-protected region;
allowing a data block to be written to the write-protected region if the size register indicates the specified number is not reached; and
enabling the write protection on the write-protected region if the size register indicates the specified number is reached.

28. The method of claim 27, further comprising:
initializing the size register to the specified number;
enabling the write protection on the write-protected region if the size register equals zero; and
decreasing the size register by one if the size register does not equal zero.

29. The method of claim 27, further comprising:
initializing the size register to zero;
enabling the write protection on the write-protected region if the size register equals the specified number; and
increasing the size register by one if the size register does not equal the specified number.
